(19) United States
(12) Patent Application Publication
(10) Pub. No.: US 2025/0174846 A1
(43) Pub. Date: May 29, 2025

(54) Battery Configuration for Directing Relative H-field Distributions

(71) Applicant: Google LLC, Mountain View, CA (US)

(72) Inventors: Shengyin Ding, Cupertino, CA (US); Yuchu He, Mountain View, CA (US)

(73) Assignee: Google LLC, Mountain View, CA (US)

(21) Appl. No.: 18/521,661

(22) Filed: Nov. 28, 2023

(51) Int. Cl. H01M 50/559; H01M 50/109; H01M 50/153; H01M 50/202; H01M 50/247; H01M 50/531; H01M 50/547; H01M 50/566; H01M 50/588; H01M 50/59; H04R 1/10

(52) U.S. Cl. CPC H01M 50/559; H01M 50/109; H01M 50/153; H01M 50/202; H01M 50/247; H01M 50/531; H01M 50/547; H01M 50/566; H01M 50/588; H01M 50/59; H04R 1/1016; H04R 1/1025; H04R 1/1041; H04R 1/1075; H01M 2220/30; H04R 2420/07

(57) ABSTRACT

The present document describes a battery configuration for directing relative H-field distributions. The battery configuration is an enclosure housing a plurality of anode and cathode layers, separated by insulation layers (e.g., a stacking cell battery, a coin cell battery, a button cell battery, etc.), with two internal tabs within the enclosure and two external tabs. The battery has a predefined external-tab configuration and a predefined internal-tab angle for reducing electromagnetic (EM) coupling. The tabs are positioned relative to one another and a symmetry axis of the battery to shape an H-field created by electric current running through the battery such that the H-field is asymmetrically distributed about the symmetry axis.

### BACKGROUND

Batteries are a key component for many electronics. Batteries with a small form factor and higher power density are becoming increasingly popular, particularly Lithium (Li) coin cells, stacked layer batteries, and other small form-factor batteries in mobile electronic devices. Recent developments in small battery-powered devices include wireless earbuds, which have a very small space to package all their components, including a networking module, a main logic board (MLB), a flex circuit, a battery, a speaker module, one or more microphones, a contact magnet, a coupling magnet, sensors, and so forth.

Challenges arise, however, in designing and producing device architecture in such small spaces for customers who generally prefer, for example, smaller, lighter, and more comfortable earbuds with a long battery life. The maximum battery life of a device correlates positively with battery size. However, a larger-size battery has more area to interface with each packaged component, which can cause issues with nearfield coupling such as unwanted electromagnetic (EM) coupling resulting in electromagnetic interference (EMI) (e.g., crosstalk in electronic circuits). Examples of unwanted EM coupling include an E-field and an H-field from an electric current and/or a static magnetic field from a magnet. EMI may occur between various electronic components, including, for example, between the MLB and the battery, between the battery and a speaker coil of the speaker module, and/or between the flex circuit and the speaker coil.

These nearfield coupling issues may be referred to as e-noise, which is an unwanted signal superimposed on a wanted signal. The e-noise may become apparent as an audible tonal noise (e.g., harmonics including 800 Hertz (Hz), 1600 Hz, 3200 Hz, etc.) via the speaker and may be recognized by a user as crackling, humming, buzzing, and/or hissing sounds, which degrades audio quality and diminishes the user experience.

### SUMMARY

The present document describes a battery configuration for directing relative H-field distributions. The battery configuration is an enclosure housing a plurality of anode and cathode layers, separated by insulation layers (e.g., a stacking cell battery, a coin cell battery, a button cell battery, etc.), with two internal tabs within the enclosure and two external tabs. The internal tabs include (i) an internal negative tab connected to the base of the battery and (ii) an internal positive tab connected to the top of the battery. The battery has a predefined external-tab configuration and a predefined internal-tab angle for reducing electromagnetic (EM) coupling. In particular, the two internal tabs are positioned such that they are separated by an angle (e.g., a predefined internal-tab angle) relative to a symmetry axis of the battery. The external tabs include (i) an external negative tab connected to a base of the enclosure and extending to overlap a side surface of the enclosure and (ii) an external positive tab connected to or substantially making up the top surface of the enclosure. Both external tabs are positioned relative to the internal tabs to shape an H-field created by electric current running through the battery such that the H-field is asymmetrically distributed about the symmetry axis.

In an example, a battery is disclosed. The battery has a symmetry about an axis and includes a battery can including a top can and a bottom can, the top can disposed at least partially within the bottom can to provide an enclosure encompassing a volume such that the top can defines a top of the enclosure, the top of the enclosure having a top interior surface and a top exterior surface, the top exterior surface defining a plane and the bottom can defines a base and a sidewall of the enclosure, the sidewall being substantially orthogonal to the plane, the base of the enclosure having a base interior surface and a base exterior surface and the sidewall of the enclosure having a sidewall interior surface and a sidewall exterior surface.

The battery further includes a plurality of layers stacked within the volume, an internal negative tab for providing a current to the plurality of layers, the internal negative tab adjacent to a first location on the base interior surface, an internal positive tab for collecting the current within the plurality of layers, the internal positive tab adjacent to a second location on the top interior surface and positioned such that an angle is created between the internal negative tab and the internal positive tab as measured in the plane about the axis, an external positive tab connected to the top exterior surface at a third location, the external positive tab defining a positive terminal for the battery and centered on the axis, and an external negative tab connected to the base exterior surface at a fourth location, the external negative tab defining a negative terminal for the battery, extending along the base exterior surface and the sidewall exterior surface, and configured such that there is a substantially greater portion of the external negative tab on one side of the axis than on an opposing side of the axis.

Additionally, the angle between the internal negative tab and the internal positive tab may be configured such that an H-field, generated by the current, has an asymmetric distribution about the axis. The angle between the internal negative tab and the internal positive tab as measured in the plane about the axis may be less than 180 degrees. According to some examples, the symmetry is a radial symmetry about the axis, the axis being a central axis. The battery may further include a weld point at the fourth location, the weld point connecting the base exterior surface to the external negative tab and made of a conductive material.

Additionally or alternately, the battery may include an insulative layer between the external negative tab and both the base exterior surface and the sidewall exterior surface, the insulative layer starting after the weld point and substantially filling an area between the enclosure and the external negative tab. The battery may further include, in some examples, an insulative layer between the top can and the bottom can. The top can may include a raised portion, the raised portion a raised portion, the raised portion situated along the top exterior surface and centered at the third location. The top can may further be defined as the external positive tab.

In another example, a device is disclosed. The device may be a mobile electronic device and may include a housing, one or more speakers coupled to the housing, and a battery coupled to the housing, the battery the battery having a symmetry about an axis and including a battery can including a top can and a bottom can, the top can disposed at least partially within the bottom can to provide an enclosure encompassing a volume such that the top can defines a top of the enclosure, the top of the enclosure having a top interior surface and a top exterior surface, the top exterior surface defining a plane and the bottom can defines a base and a sidewall of the enclosure, the sidewall being substantially orthogonal to the plane, the base of the enclosure having a base interior surface and a base exterior surface and the sidewall of the enclosure having a sidewall interior surface and a sidewall exterior surface.

The battery may further include a plurality of layers stacked within the volume, an internal negative tab for providing current to the plurality of layers, the internal negative tab being adjacent to a first location on the base interior surface, an internal positive tab for collecting the current within the plurality of layers, the internal positive tab adjacent to a second location on the top interior surface and positioned such that an angle is created between the internal negative tab and the internal positive tab as measured in the plane about the axis, an external positive tab connected to the top exterior surface at a third location, the external positive tab defining a positive terminal for the battery and centered on the axis, and an external negative tab connected to the base exterior surface at a fourth location, the external negative tab defining a negative terminal for the battery, extending along the base to the sidewall of the enclosure, and configured such that there is a substantially greater portion of the external negative tab on one side of the axis than on an opposing side of the axis.

Additionally, the angle between the internal negative tab and the internal positive tab may be configured such that an H-field, generated by the current, has an asymmetric distribution about the axis. The angle between the internal negative tab and the internal positive tab as measured in the plane about the axis may be less than 180 degrees. According to some examples, the one or more speakers are coupled to the housing opposite to a region of greatest concentration of the H-field. In aspects, the mobile electronic device may be one of a pair of wireless earbuds. Additionally, the symmetry may be a radial symmetry about the axis, and the axis may be a central axis. According to some examples, the battery further includes a weld point at the fourth location, the weld point connecting the base exterior surface to the external negative tab and made of a conductive material.

In some examples, the battery of the mobile electronic device further includes an insulative layer between the external negative tab and both the base and the sidewall exterior surfaces, the insulative layer starting after the weld point and substantially filling an area between the enclosure and the external negative tab. According to some examples, the battery further includes an insulative layer between the top can and the bottom can. The top can may include a raised portion, the raised portion situated along the top exterior surface and centered at the third location. In aspects, the top can may define the external positive tab.

This summary is provided to introduce simplified concepts of a battery configuration for directing relative H-field distributions, which are further described below in the Detailed Description. This summary is not intended to identify essential features of the claimed subject matter.

### BRIEF DESCRIPTION OF THE DRAWINGS

The details of one or more aspects of a battery configuration for directing relative H-field distributions are described in this document with reference to the following drawings. The same numbers are used throughout the drawings to reference like features and components:

FIG. 1 is an example implementation of a battery configuration for directing relative H-field distributions;

FIG. 2 illustrates another perspective view of the example battery from FIG. 1 with additional detail;

FIG. 3 illustrates a top plan view of the example battery from FIG. 1;

FIG. 4 illustrates a sectional view of stacked layers from the example battery from FIG. 2;

FIG. 5 illustrates a directionality of a current flow in the example battery of FIG. 2;

FIG. 6 illustrates another perspective view of a directionality of a current flow in the example battery of FIG. 1;

FIG. 7 illustrates a top plan view of a directionality of the current flow in the example battery of FIG. 3;

FIG. 8 illustrates an internal flow directionality of a current in an example implementation of a battery configuration for directing relative H-field distributions;

FIG. 9 illustrates another perspective view of an internal flow directionality of the current in the example implementation of the battery configuration for directing relative H-field distributions of FIG. 8;

FIG. 10 depicts two example styles for a top can of the example battery from FIG. 1;

FIG. 11 illustrates four example styles for external negative terminals for the example battery from FIG. 1;

FIG. 12 depicts an example device employing a battery configuration for directing relative H-field distributions; and

FIG. 13 illustrates a top plan view of relative H-field distributions in the example device of FIG. 12.

### DETAILED DESCRIPTION

The present document describes a battery configuration for directing relative H-field distributions. Electric current running through a battery generates a magnetic field (H-field), which can induce nearfield coupling (e.g., electromagnetic coupling) with a nearby electronic circuit and cause unwanted electromagnetic interference. In some examples, this nearfield coupling is presented in the form of e-noise, which can produce an audible tonal sound (e.g., crackling, humming) via a speaker. The battery configuration described herein includes an enclosure housing a plurality of anode and cathode layers, separated by insulation layers (e.g., a stacking cell battery, a coin cell battery, a button cell battery, etc.), with two internal tabs within the enclosure and two external tabs on the exterior surface of the enclosure. The battery has a predefined external-tab configuration and a predefined internal-tab angle for reducing electromagnetic (EM) coupling. The tabs are positioned relative to one another and relative to a symmetry axis of the battery to shape an H-field created by an electric current running through the battery such that the H-field is asymmetrically distributed about the symmetry axis. This shaping creates an area of low H-field density and an area of high H-field density (relative to one another).

Thus, a battery is provided for devices (e.g., small form factor devices) that reduces EMI (e.g., e-noise) typically created between a battery and a nearby electronic component (e.g., speaker, main logic board, circuit, etc.). By way of example, a speaker in an earbud can experience EMI via coupling its H-field with the H-field from the battery current, thus passing on unwanted noise artifacts to an end user. Placement of the speaker in an area with lower relative H-field density lowers effects from EMI. The disclosed battery configuration thereby increases the effectiveness, efficiency, and user satisfaction with devices and systems using the battery.

While features and concepts of the described techniques for a battery configuration for directing relative H-field distributions can be implemented in any number of different environments, aspects are described in the context of the following examples. The examples described herein that discuss current flow are described with respect to when the battery is discharging under load. Accordingly, when charging the battery, the direction of the current is opposite to the direction described herein.

### Example Batteries

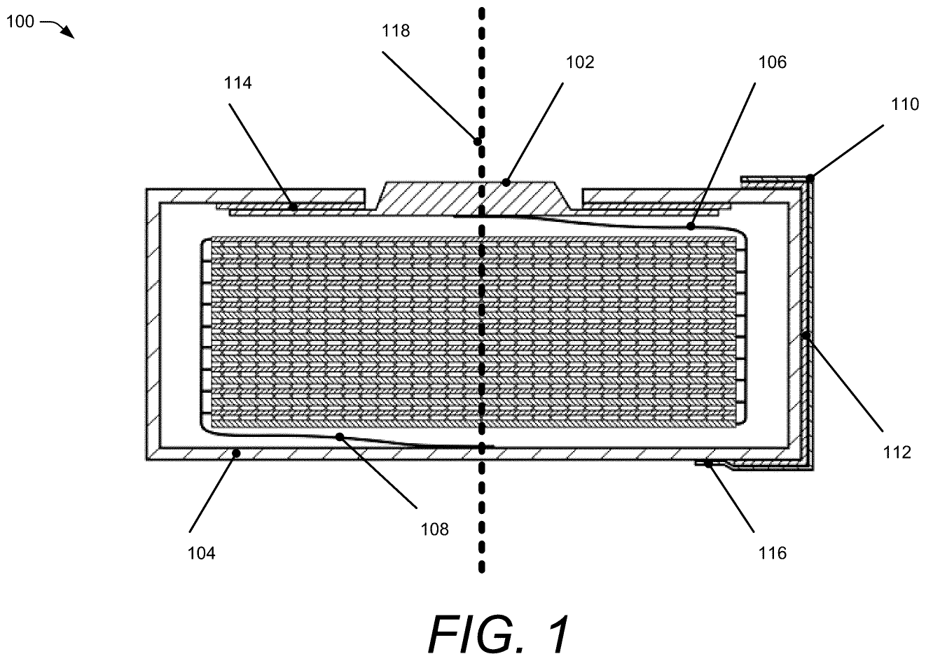

FIG. 1 is an example implementation of a battery configuration for directing relative H-field distributions. The illustrated example includes a battery 100 (e.g., a stacking cell battery, a coin cell battery, a button cell battery, etc.) having an enclosure (e.g., can, battery can, etc.), which includes a top can 102 and a bottom can 104. In aspects, the top can 102 defines a top of the enclosure and the bottom can 104 defines a base and a sidewall of the enclosure. The top can 102 forms a positive terminal on the top, and the bottom can 104 forms a negative terminal on both the base and the sidewall. The top of the enclosure has a top exterior surface defining a plane, the top exterior surface substantially comprised by the top can 102. The battery 100 also includes an internal positive tab 106 and an internal negative tab 108. The internal positive tab 106 is adjacent to the top can 102, and the internal negative tab 108 is adjacent to the bottom can 104. This provides an electrical connection between the internal positive tab 106 and the top can 102 and between the internal negative tab 108 and the bottom can 104.

The enclosure may have both internal and external surfaces such that there is an external top surface, an internal top surface, an external bottom surface, an internal bottom surface, an external sidewall surface, and an internal sidewall surface. In aspects, the internal positive tab 106 may be adjacent to the top interior surface of the enclosure and the internal negative tab 108 may be adjacent to the bottom interior surface of the enclosure.

The battery 100 further includes an external negative tab 110. The external negative tab 110 is attached to and electronically isolated from the bottom can 104 by a first adhesive 112. The first adhesive 112 may substantially fill the area between the external negative tab 110 and the exterior base and the exterior sidewall surfaces. Similarly, the top can 102 is attached to and electronically isolated from the bottom can 104 by a second adhesive 114. The external negative tab 110 is physically and electronically connected to the bottom can 104 at the bottom exterior surface by a weld point 116, the weld point 116 made of a conductive material, such as Al, Cu, or another suitable conductive material. The top exterior surface of the top can 102 may also serve as an external positive tab 102. In one example, the external positive tab 102 is an anode tab and the external negative tab 110 is a cathode tab. The external positive tab 102 is shown as being in a middle of the battery 100, “the middle” defined such that there is substantially the same amount of material of the battery 100 on any defined side of the external positive tab 102 compared with an opposing side of equal area and/or volume, wherein the sides are defined by considering equal areas/volumes of the external positive tab 102 about the middle of the external positive tab 102 in the plane. By contrast, the external negative tab 110 does not have the same configuration. If an axis of symmetry 118 is defined as a line around which there is equal physical volume of the battery 100, the external positive tab 102 is centered around the axis of symmetry 118. The external negative tab 110 is to one side of the axis of symmetry 118.

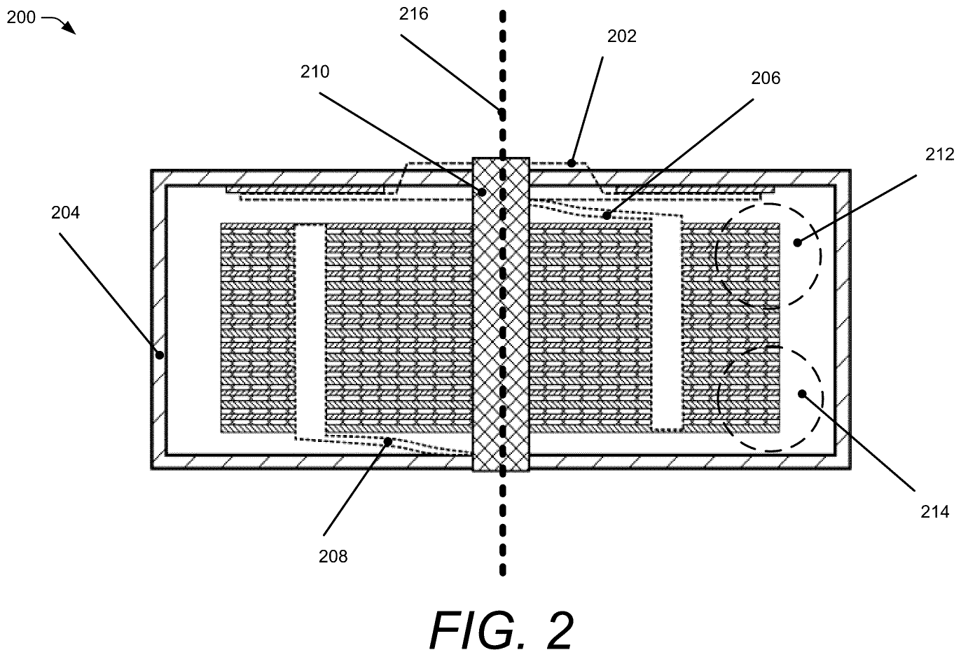

FIG. 2 illustrates another perspective view of the example battery from FIG. 1 with additional detail. The illustrated example shows a battery 200, like the example battery 100, including a top can 202, a bottom can 204, an internal positive tab 206, an internal negative tab 208, and an external negative tab 210. The top can 202 and the bottom can 204 again form an enclosure. Areas 212 and 214 show stacked layers of anode, cathode, and insulation layers, the anode and cathode layers allowing for a flow of a current through the battery 200. The battery 200 has an axis of symmetry 216, as described in the example battery of FIG. 1. By way of example, the symmetry centered on the axis of symmetry 216 may be a radial symmetry, a bilateral symmetry, or some other form of symmetric relationship. In FIG. 2, the external negative tab 210 is in line with the axis of symmetry 216, but the external negative tab 210 will not be in line with the axis of symmetry 216 if the view is rotated, as in FIG. 1. The external negative tab 210 may therefore not be centered about the axis of symmetry 216.

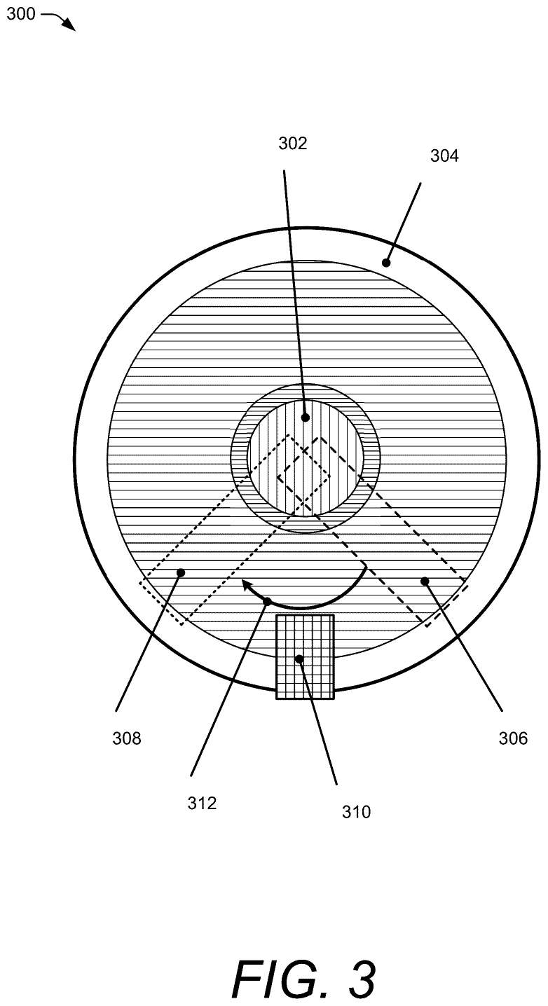

FIG. 3 illustrates a top plan view of the example battery from FIG. 1. The illustrated example shows a battery 300, like the example batteries 100 and 200. The battery 300 includes a top can 302, a bottom can 304, an internal positive tab 306, an internal negative tab 308, and an external negative tab 310. The top can 302 may also serve as an external positive tab 302. The external positive tab 302 is centered along an axis of symmetry, such as the axes of symmetry 118 and 216. By way of example, the symmetry centered on the axis of symmetry may be a radial symmetry, as in the example battery 200. The axis of symmetry may, in this way, be a central axis. The internal positive tab 306 and the internal negative tab 308 are shown as dashed boxes as they are not visible in this view. The internal positive tab 306 and the internal negative tab 308 each have an end at the axis of symmetry, in-line with the center of the external positive tab 302 in this view.

The orientation of the internal positive tab 306 and the internal negative tab 308 may be such that an angle 312 is created between them. The angle 312 is in a plane orthogonal to the axis of symmetry. The angle 312 is less than 180° in the plane, such that the ends of the internal positive tab 306 and the internal negative tab 308 that are not at the axis of symmetry are closer to one another along a circular path in the battery 300 going one direction as opposed to the other. For example, if measuring in a semicircular line from an outside end of the internal positive tab 306 to an outside end of the internal negative tab 308, in a direction similar to the path of the arrow indicating the angle 312, there will be less distance covered than were the measurement to start from the same point but the semicircular line be measured in the opposite direction. If the angle 312 were to be 180°, the measurements would be the same in both directions. It should be understood that an angle less than 180° corresponds with, and is identical to, an angle greater than 180° as measured in the opposite direction in the plane.

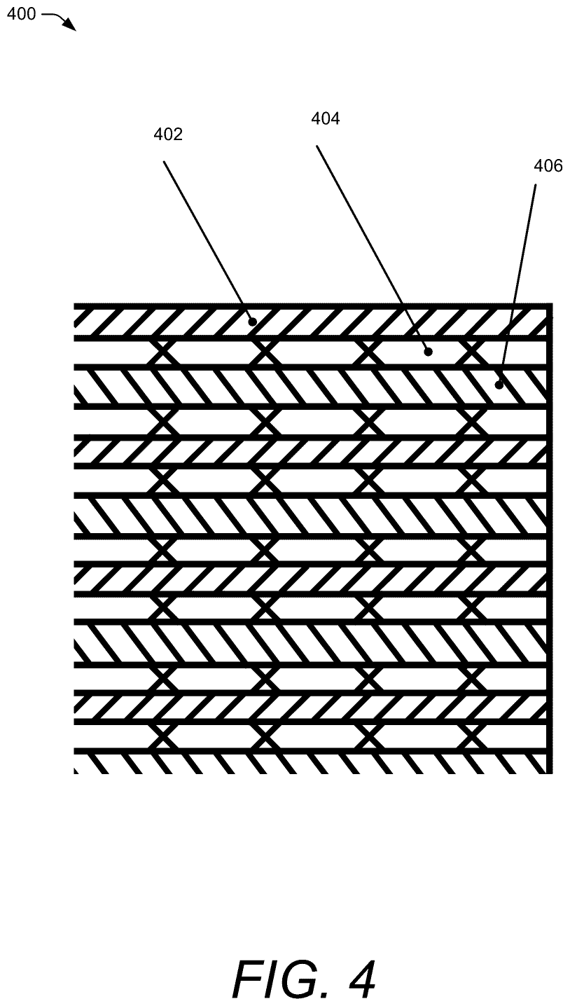

FIG. 4 illustrates a sectional view of the stacked layers from the example battery from FIG. 2. The illustrated example shows an inner portion of a battery 400. The inner portion of the battery 400 includes one or more cathode layers 402, one or more insulation layers 404, and one or more anode layers 406. The configuration shown in the example inner portion of the battery 400 may be a stacked layer type battery (e.g., a stacking cell battery, a coin cell battery, a button cell battery, etc.).

Any one of the example batteries 100, 200, 300, and 400 may be a Li-ion battery. Various Li-ion-battery chemistries may be implemented, some examples of which include lithium cobalt oxide (LiCoO2), lithium iron phosphate (LiFePO4), lithium manganese oxide (LiMn2O4 spinel, or Li2MnO3-based lithium-rich layered materials, LMR-NMC), and lithium nickel manganese cobalt oxide (LiNiMnCoO2, Li-NMC, LNMC, NMC, or NCM and the various ranges of Co stoichiometry). Also, Li-ion batteries may include various anode materials, including graphite-based anodes, silicon (Si), graphene, and other cation intercalation/insertion/alloying anode materials. The one or more cathode layers 402, the one or more insulation layers 404, and the one or more anode layers 406 may be a plurality of stacked, interleaved layers arranged such that the one or more cathode layers 402 are not in direct electrical or physical connection with the one or more anode layers 406 due to the interleaving of the one or more insulation layers 404.

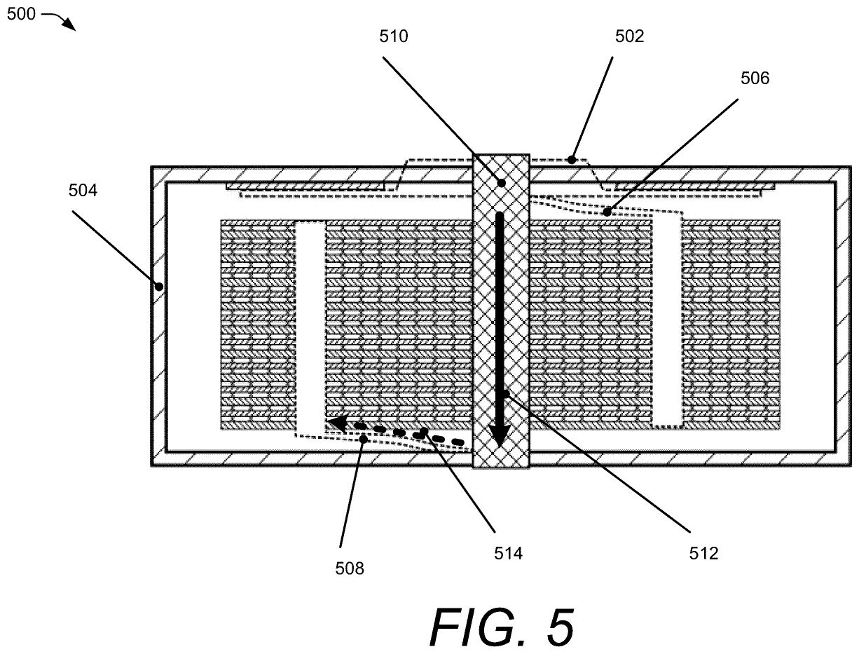

FIG. 5 illustrates a directionality of a current flow in the example battery of FIG. 2. The illustrated example shows a battery 500. The battery 500 includes a top can 502 and a bottom can 504, the top can 502 and the bottom can 504 making an enclosure. The battery 500 further includes an internal positive tab 506 and an internal negative tab 508. The battery 500 also includes an external negative tab 510. The top can 502 may also serve as an external positive tab 502. When current is flowing through the battery 500, it may flow along the external negative tab 510, as indicated by a first current flow arrow 512, and along the internal negative tab 508, as indicated by a second current flow arrow 514.

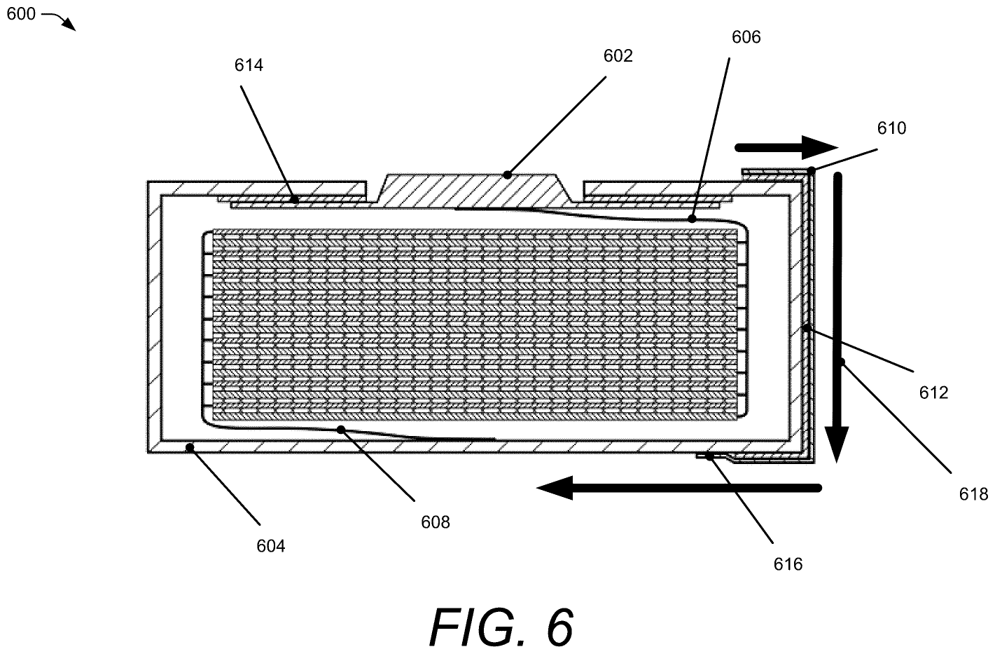

FIG. 6 illustrates another perspective view of a directionality of a current flow in the example battery of FIG. 1. The illustrated example shows a battery 600. The battery 600 includes a top can 602 and a bottom can 604, which make an enclosure. The battery 600 further includes an internal positive tab 606, an internal negative tab 608, and an external negative tab 610. The top can 602 may also serve as an external positive tab 602. The battery 600 further includes an external negative tab 610, the external negative tab 610 electronically separated and physically connected to a sidewall of the enclosure created by the bottom can 604 by a first insulating adhesive 612. Similarly, the external positive tab 602 is electronically separated and physically connected to a top of the enclosure created by the bottom can 604 by a second insulating adhesive 614. The external negative tab 610 is connected both physically and electronically to the bottom can 604 by a weld point 616.

When the current is flowing through the battery 600, it may follow a path down the external negative tab 610, as indicated by arrows 618. The flow of electricity may be mathematically represented by an electromotive force:

$$ϵ = \int \vec{E} \cdot d \vec{l} \qquad ( 1 )$$

Equation 1 shows an electromotive force ϵ being equal to an electric field (E-field) integrated over a distance and direction. Faraday's Law further states:

$$ϵ = - \frac{d {Φ}_{B}}{dt} \qquad ( 2 )$$

Equation 2 equates ϵ with a changing magnetic flux, Φ_{B}, which may be defined as:

$${Φ}_{B} = {\int }_{S} {μ}_{0} \vec{H} \cdot d \vec{A} \qquad ( 3 )$$

Equations 1, 2, and 3 demonstrate that a current, such as that indicated by the arrows 618, may in turn motivate an H-field. Additionally, there may be a direct correlation between the strength and/or density of c and the associated H-field, as demonstrated by Equations 1, 2, and 3.

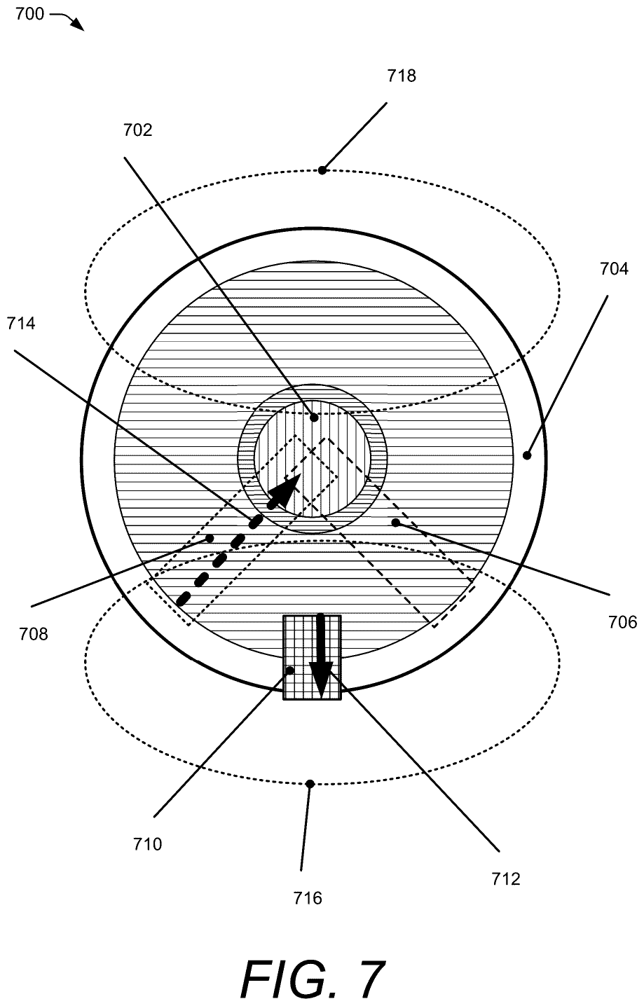

FIG. 7 illustrates a top plan view of a directionality of a current flow in the example battery of FIG. 3. The illustrated example shows a battery 700, similar to the example batteries 100, 200, 300, 400, 500, and 600. The battery 700 includes a top can 702, a bottom can 704, an internal positive tab 706, an internal negative tab 708, and an external negative tab 710. The top can 702 may also serve as an external positive tab 702. The external positive tab 702 is centered along an axis of symmetry, such as the axes of symmetry 118 and 216. The internal positive tab 706 and the internal negative tab 708 are shown as dashed boxes as they are not visible in this view. The internal positive tab 706 and the internal negative tab 708 each have an end at the axis of symmetry, in-line with the center of the external positive tab 702 in this view.

When there is current flowing through the battery 700, the current may flow down the external negative tab 710, as shown by a first current arrow 712. The current may further flow through the internal negative tab 708, as indicated by a second current arrow 714. Given the geometry of the internal negative tab 708 in relation to the internal positive tab 706, as outlined for FIG. 3, there is a greater current density in the region of a first area 716 than there is in the region of a second area 718. The region in the first area 716 will therefore have a greater H-field density than the H-field density in the region in the second area 718.

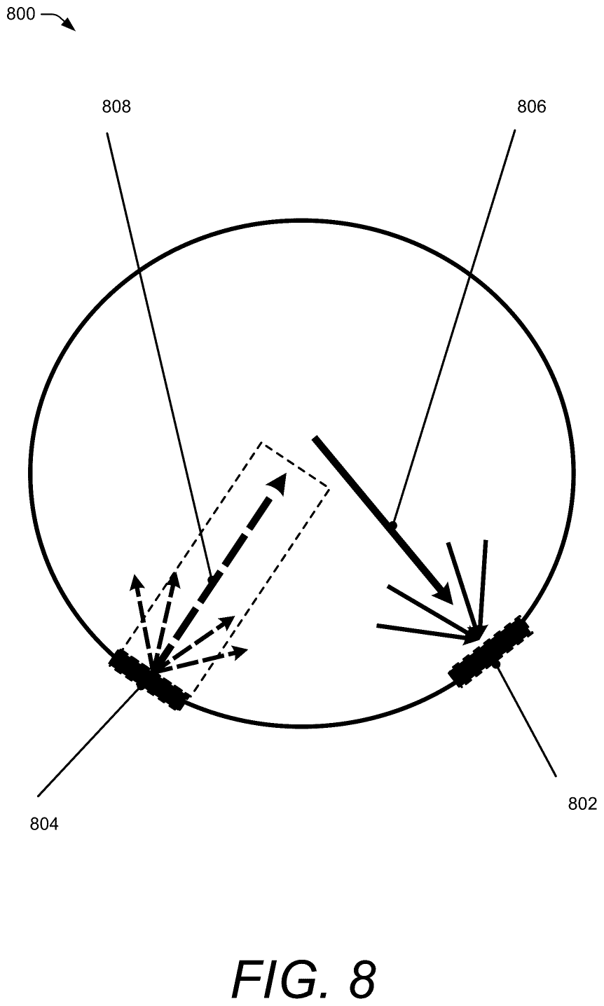

FIG. 8 illustrates an internal flow directionality of a current in an example implementation of a battery configuration for directing relative H-field distributions. The illustrated example shows a battery 800 with an internal positive tab 802 and an internal negative tab 804. Consider a single cathode layer 402 and a single anode layer 406 from the example battery 400 of FIG. 4. The single cathode layer 402 may be a top cathode layer, attached to the internal positive tab 802. Similarly, the single anode layer 406 may be a bottom anode layer, attached to the internal negative tab 804.

In the example as illustrated, current will flow from the single cathode layer 402 into the internal positive tab 802, as indicated by cathode current flow arrows 806. The cathode current flow arrows 806 propagate in all directions in a 180° arc, with the center of the arc at 90° in an outward direction (e.g., toward the internal positive tab 802, away from a symmetry axis of the battery 800). This spread results in all vectors associated with the cathode current flow, as indicated by the cathode current flow arrows 806, having a component at 90° and, thus, a net current flow away from the center or symmetry axis of the battery 800.

Similarly, current will flow from the internal negative tab 804 into the single anode layer 406, as indicated by anode current flow arrows 808. The anode current flow arrows 808 propagate in all directions in a 180° arc, with the center of the arc at 90° in an inward direction (e.g., toward the center or symmetry axis of the battery 800). This spread results in all vectors associated with the anode current flow, as indicated by the anode current flow arrows 808, having a component at 90° and, thus, a net current flow toward the center or symmetry axis of the battery 800.

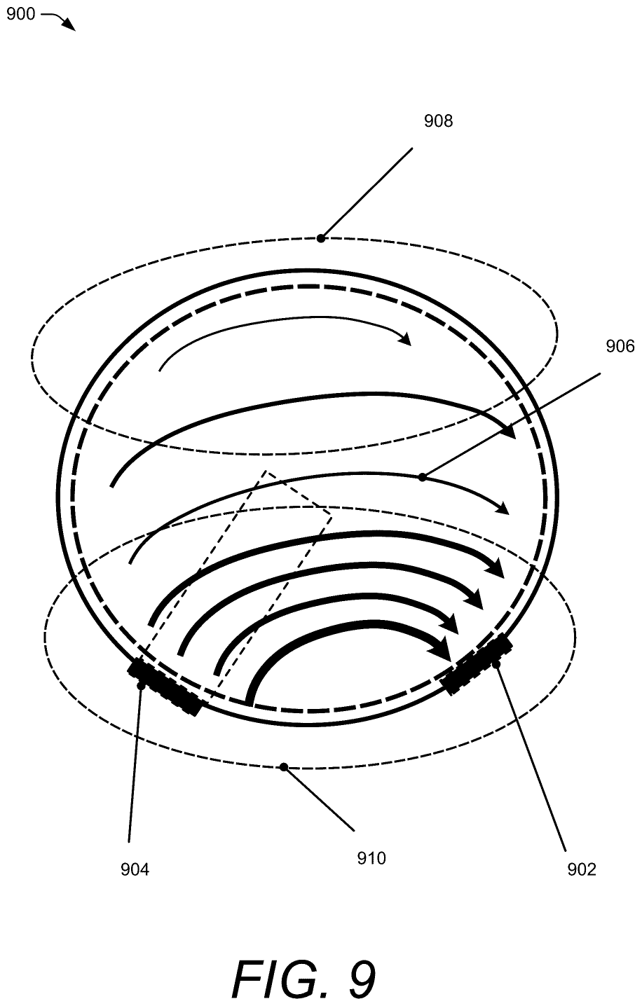

FIG. 9 illustrates another perspective view of an internal flow directionality of the current in the example implementation of the battery configuration for directing relative H-field distributions of FIG. 8. The illustrated example shows a battery 900, the battery 900 including an internal positive tab 902 and an internal negative tab 904. Current flow lines 906 indicate overall net paths of the electrical current through stacked anode and cathode layers within the battery 900, as outlined in FIGS. 1, 2, 4-6, and 8. Ampere's Law shows the relationship between the electric current and the H-field:

$$∇ \times \vec{H} = \vec{J} + \frac{d \vec{D}}{dt} \qquad ( 4 )$$

Equation 4 may be represented in integral form as:

$$∮ \vec{H} \cdot d \vec{l} = \int \int ( \vec{J} + \frac{d \vec{D}}{d t} ) \cdot d \vec{S} \qquad ( 5 )$$

In both Equations 4 and 5, 17 represents an H-field. Considering the case where

$$\frac{d \vec{D}}{dt} = 0$$

(e.g., no changing E-field in the medium of the battery 900), a surface area, such as a first area 908 or a second area 910, will have its H-field determined by an amount and a magnitude of current encompassed by it. The first area 908 encompasses fewer current flow lines 906 than does the second area 910. This may be based on the geometry of the battery 900, particularly how internal and external positive and negative tabs (e.g., the internal positive tab 902, the internal negative tab 904, etc.) are situated in the battery 900 relative to one another and the symmetry axis of the battery 900. As the current, as indicated by the current flow lines 906, is motivated by an E-field (Equations 1, 2, and 3), if there is a changing E-field

$$( i . e . , \frac{d \vec{D}}{dt} \neq 0 ) ,$$

the associated H-field will still have a greater density where there are areas of greater current flow density.

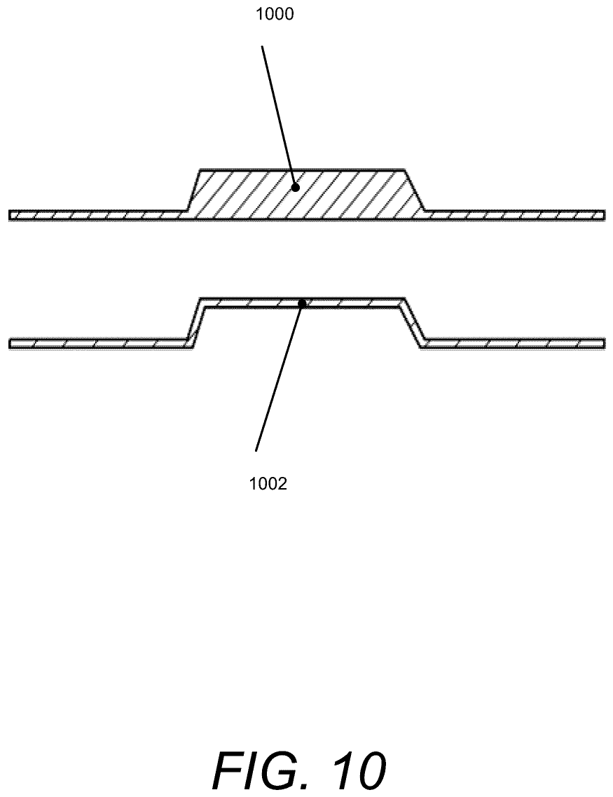

FIG. 10 depicts two example styles for the top can of the example battery from FIG. 1. A top can 1000 represents a first style, which can be used as an external positive tab 1000 for a battery as described in this disclosure. The top can 1000 may be a product of die-cut manufacturing or any other form of manufacture where the top can 1000 is cut or formed from a parent piece of material. The top can 1000 may be a product of an injection molding style of manufacturing or another manufacture process where a material may be formed to a predetermined shape. The material in either process may be a homogenous material, such as Al, Cu, Au, Ag, or another conductive material, or it may be a composite material. The top can 1000 includes a raised portion on one surface and a substantially flat portion on an opposing surface.

A top can 1002 represents a second style, which can be used as an external positive tab 1002 for a battery as described in this disclosure. The top can 1002 may be a product of a press or stamping manufacture or another manufacture type where a material is pressure-fit, heat-fit, or otherwise fit to a mold to conform the material to a predetermined shape. The material used to manufacture the top can 1002 may be Al, Cu, Au, Ag, or another conductive material, including composite materials. The top can 1002 includes a raised portion on one surface and a corresponding depressed portion on an opposing surface.

The top cans 1000 and 1002 may exhibit different electrical properties, such as, but not limited to, resistance, inductance, current flow properties, or other electrical properties. The top cans 1000 and 1002 may also have different manufacturing costs or concerns. Choosing the ideal type of top can 1000 or 1002 will depend on these and other properties and differences.

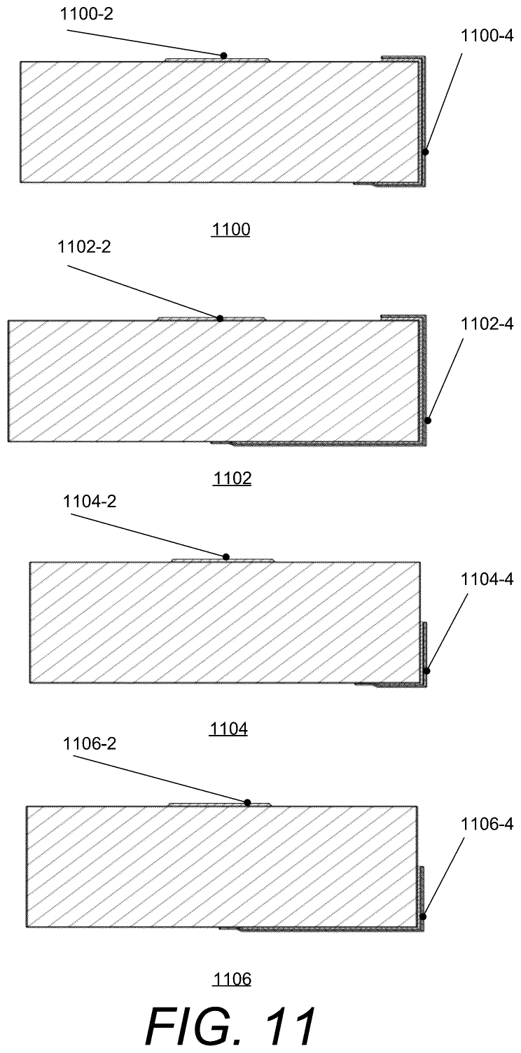

FIG. 11 illustrates four example styles for external negative terminals for the example battery from FIG. 1. The illustrated example shows a battery 1100, a battery 1102, a battery 1104, and a battery 1106. Each of the batteries 1100, 1102, 1104, and 1106 has an external positive tab 1100-2, 1102-2, 1104-2, and 1106-2, respectively, and an external negative tab 1100-4, 1102-4, 1104-4, and 1106-4, respectively. The external negative tabs 1100-4 and 1102-4 are incident upon the entire length of a sidewall of the batteries 1100 and 1102, respectively, and along portions of a bottom and a top of the batteries 1100 and 1102, respectively. These configurations for the external negative tabs 1100-4 and 1102-4 may be referred to as C-type tabs. The external negative tabs 1104-4 and 1106-4 are incident upon a portion of a bottom and a portion of a sidewall of the batteries 1104 and 1106, respectively. These configurations for the external negative tabs 1104-4 and 1106-4 may be referred to as L-type tabs.

L-type and C-type tabs may have different electrical properties, such as resistance and current propagation properties, among others. There may also be differences between members of a type, such as different configurations of L-type tabs or different configurations of C-type tabs. By way of example, the L-type tabs 1104-4 and 1106-4 differ in their overall length along the bottom of the batteries 1104 and 1106, respectively. In another example, the C-type tabs 1100-4 and 1102-4 also differ in their overall length along the bottom of the batteries 1100 and 1102, respectively. Concern may be given to a different tab configuration type (e.g., L-type, C-type, etc.) or different variation within a type (e.g., the differences between the C-type external negative tabs 1100-4 and 1102-4, the differences between the L-type external negative tabs 1104-4 and 1106-4, etc.) based on the cost of manufacture, ease of manufacture, mass producibility, electrical properties, or other properties associated with the different tab types and configurations within tab types.

### Example Devices

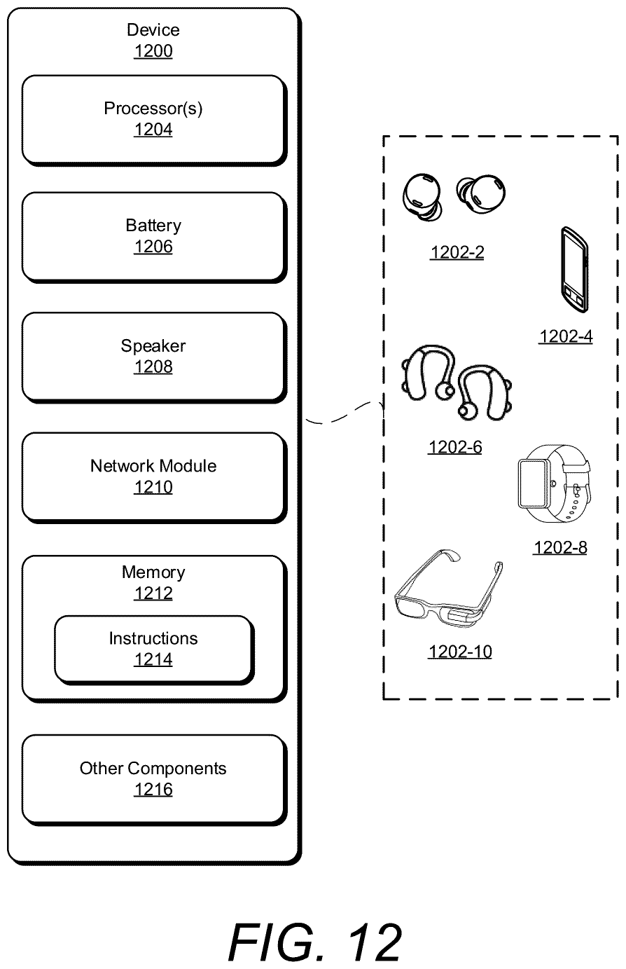

FIG. 12 depicts an example device employing a battery configuration for directing relative H-field distributions. The device 1200 is illustrated with a variety of example devices, including wireless earbuds 1202-2, a smartphone 1202-4, hearing aids 1202-6, a smartwatch 1202-8, and smart glasses 1202-10. The device 1200 can be mobile, wearable, non-wearable but mobile, or relatively immobile. The device 1200 is a small form factor device that is battery-powered. The example devices disclosed herein are meant to be illustrative and not limiting.

The device 1200 may be a mobile electronic device. The device 1200 includes one or more processors 1204 (e.g., any of microprocessors, microcontrollers, other controllers, etc.) that can process various computer-executable instructions to control the operation of the device 1200. The device 1200 further includes a battery 1206 (e.g., battery 100, battery 200, etc.). As described herein, the battery 1206 may be a Li-ion battery. Various Li-ion-battery chemistries may be implemented, some examples of which include lithium cobalt oxide (LiCoO2), lithium iron phosphate (LiFePO4), lithium manganese oxide (LiMn2O4 spinel, or Li2MnO3-based lithium-rich layered materials, LMR-NMC), and lithium nickel manganese cobalt oxide (LiNiMnCoO2, Li-NMC, LNMC, NMC, or NCM and the various ranges of Co stoichiometry). Also, Li-ion batteries may include various anode materials, including graphite-based anodes, silicon (Si), graphene, and other cation intercalation/insertion/alloying anode materials.

The device 1200 may also include a speaker 1208. The speaker 1208 may include any suitable speaker for outputting audio signals, whether for notifications, alerts, music, speech, or other audio messages for a user. The speaker 1208 may be integrated within the device 1200 such that the speaker 1208 is located within a housing of the device 1200. The speaker 1208 may include component parts, such as one or more magnets, coiled wires for carrying an electric current, and other components known to a person of ordinary skill in the art. EMI from other devices or components may interfere with electromagnetic components of the speaker 1208, such as by H-field coupling.

The device 1200 may also include a network module 1210. The device 1200 can use the network module 1210 for communicating data over wired, wireless, optical, or audio (e.g., acoustic) networks. By way of example and not limitation, the network module 1210 may communicate data over a local area network (LAN), a wireless local area network (WLAN), a home area network (HAN), a personal area network (PAN), a wide area network (WAN), an intranet, the Internet, a peer-to-peer network, a point-to-point network, or a mesh network. The network module 1210 can be implemented as one or more of a serial and/or parallel interface, a wireless interface, any type of network interface, a modem, or any other type of communication interface. Using the network module 1210, the device 1200 may communicate via a cloud computing service to access a platform having resources.

The device 1200 also includes a memory 1212 that provides storage for various instructions 1214 or other components not listed, such as applications and system data. Applications, an operating system, etc. may be implemented as computer-readable instructions 1214 on the memory 1212 and can be executed by the processor(s) 1204. The memory 1212 may be described as a computer-readable media and may provide data storage mechanisms to store various device applications, the operating system, and other types of information and/or data related to operational aspects of the device 1200. For example, the operating system can be maintained as a computer application within the memory 1212 and executed by the processor(s) 1204.

The device 1200 may also include other components 1216 known to a person of ordinary skill in the art, such as, but not limited to, one or more battery connectors, a display, an enclosure, one or more printed circuit boards, and so forth.

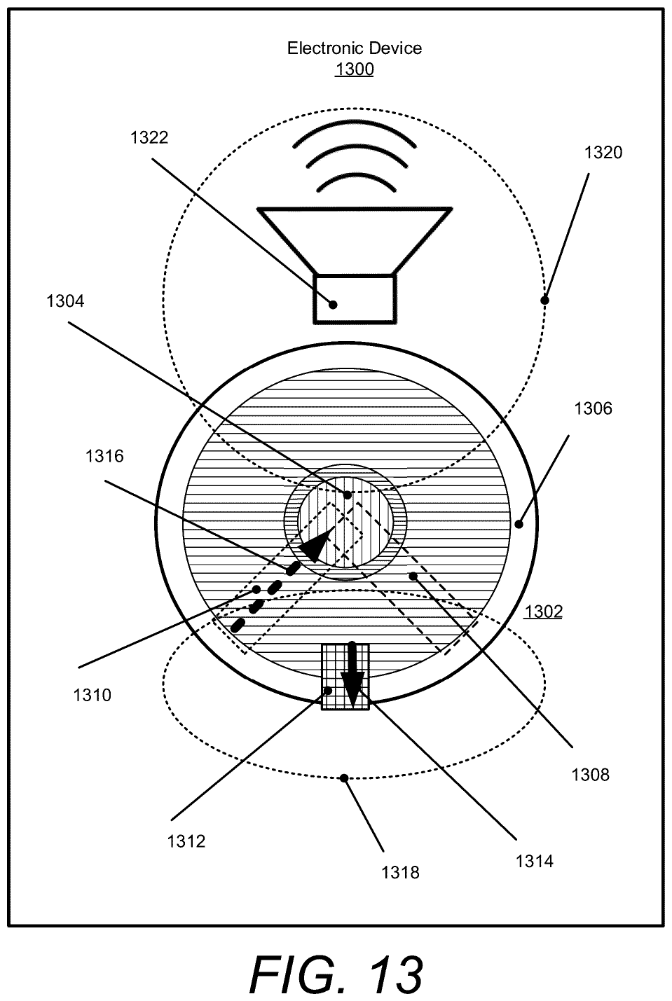

FIG. 13 illustrates a top plan view of relative H-field distributions in the example device of FIG. 12. An electronic device 1300 is illustrated, such as the device 1200. The electronic device 1300 includes a battery 1302 (e.g., battery 100, battery 200, etc.). The battery 1302 includes a top can 1304 that may serve as an external positive tab 1304. The battery 1302 further includes a bottom can 1306, which may serve as a bottom, sidewalls, and part of a top of an enclosure, the enclosure including the top can 1304. The battery 1302 further includes an internal positive tab 1308, an internal negative tab 1310, and an external negative tab 1312.

An electric current may flow through the battery 1302 when in use, as indicated by an external flow arrow 1314 and an internal flow arrow 1316 along the external negative tab 1312 and the internal negative tab 1310, respectively. The geometry of the tabs 1304, 1308, 1310, and 1312 relative to a symmetry of the battery 1302, as described earlier in this disclosure, may result in areas of relatively different H-field distributions based on this geometry and the current flow. For example, a first area 1318 may have a much higher relative average H-field intensity than a second area 1320.

The electronic device 1300 may further include a speaker 1322. The placement of the speaker 1322 may be idealized by choosing an area of the electronic device 1300 that is least likely to have adverse EMI effects due to H-field coupling from current running through the battery 1302. As outlined, the first area 1318 may have a much higher relative average H-field intensity or concentration than the second area 1320, which may indicate the second area 1320 as a more ideal placement candidate for the speaker 1322.

### CONCLUSION

Although aspects of a battery configuration for directing relative H-field distributions have been described in language specific to features and/or methods, the subject of the appended claims is not necessarily limited to the specific features or methods described. Rather, the specific features and methods are disclosed as example implementations of techniques for a battery configuration for directing relative H-field distributions, and other equivalent features and methods are intended to be within the scope of the appended claims. Further, various different aspects are described, and it is to be appreciated that each described aspect can be implemented independently or in connection with one or more other described aspects.

What is claimed is:

1. A battery having a symmetry about an axis and comprising:
a battery can comprising a top can and a bottom can, the top can disposed at least partially within the bottom can to provide an enclosure encompassing a volume such that:
the top can defines a top of the enclosure, the top of the enclosure having a top interior surface and a top exterior surface, the top exterior surface defining a plane; and
the bottom can defines a base and a sidewall of the enclosure, the sidewall being substantially orthogonal to the plane, the base of the enclosure having a base interior surface and a base exterior surface and the sidewall of the enclosure having a sidewall interior surface and a sidewall exterior surface;
a plurality of layers stacked within the volume;
an internal negative tab for providing a current to the plurality of layers, the internal negative tab adjacent to a first location on the base interior surface;
an internal positive tab for collecting the current within the plurality of layers, the internal positive tab adjacent to a second location on the top interior surface and positioned such that an angle is created between the internal negative tab and the internal positive tab as measured in the plane about the axis;
an external positive tab connected to the top exterior surface at a third location, the external positive tab defining a positive terminal for the battery and centered on the axis; and
an external negative tab connected to the base exterior surface at a fourth location, the external negative tab defining a negative terminal for the battery, extending along the base exterior surface and the sidewall exterior surface, and configured such that there is a substantially greater portion of the external negative tab on one side of the axis than on an opposing side of the axis.

2. The battery of claim 1, wherein the angle between the internal negative tab and the internal positive tab is configured such that an H-field, generated by the current, has an asymmetric distribution about the axis.

3. The battery of claim 2, wherein the angle between the internal negative tab and the internal positive tab as measured in the plane about the axis is less than 180 degrees.

4. The battery of claim 1, wherein the symmetry is a radial symmetry about the axis, the axis being a central axis.

5. The battery of claim 1, further comprising a weld point at the fourth location, the weld point:
connecting the base exterior surface to the external negative tab; and
comprising a conductive material.

6. The battery of claim 5, further comprising an insulative layer between the external negative tab and both the base exterior surface and the sidewall exterior surface, the insulative layer:
starting after the weld point; and
substantially filling an area between the enclosure and the external negative tab.

7. The battery of claim 1, further comprising an insulative layer between the top can and the bottom can.

8. The battery of claim 7, wherein the top can comprises a raised portion, the raised portion:
situated along the top exterior surface; and
centered at the third location.

9. The battery of claim 8, wherein the top can further comprises the external positive tab.

10. A mobile electronic device, comprising:
a housing;
one or more speakers coupled to the housing; and
a battery coupled to the housing, the battery having a symmetry about an axis and comprising:
a battery can comprising a top can and a bottom can, the top can disposed at least partially within the bottom can to provide an enclosure encompassing a volume such that:
the top can defines a top of the enclosure, the top of the enclosure having a top interior surface and a top exterior surface, the top exterior surface defining a plane; and
the bottom can defines a base and a sidewall of the enclosure, the sidewall being substantially orthogonal to the plane, the base of the enclosure having a base interior surface and a base exterior surface and the sidewall of the enclosure having a sidewall interior surface and a sidewall exterior surface;
a plurality of layers stacked within the volume;
an internal negative tab for providing current to the plurality of layers, the internal negative tab being adjacent to a first location on the base interior surface;
an internal positive tab for collecting the current within the plurality of layers, the internal positive tab adjacent to a second location on the top interior surface and positioned such that an angle is created between the internal negative tab and the internal positive tab as measured in the plane about the axis;
an external positive tab connected to the top exterior surface at a third location, the external positive tab defining a positive terminal for the battery and centered on the axis; and
an external negative tab connected to the base exterior surface at a fourth location, the external negative tab defining a negative terminal for the battery, extending along the base to the sidewall of the enclosure, and configured such that there is a substantially greater portion of the external negative tab on one side of the axis than on an opposing side of the axis.

11. The mobile electronic device of claim 10, wherein the angle between the internal negative tab and the internal positive tab is configured such that an H-field, generated by the current, has an asymmetric distribution about the axis.

12. The mobile electronic device of claim 11, wherein the angle between the internal negative tab and the internal positive tab as measured in the plane about the axis is less than 180 degrees.

13. The mobile electronic device of claim 11, wherein the one or more speakers are coupled to the housing opposite to a region of greatest concentration of the H-field.

14. The mobile electronic device of claim 10, wherein the mobile electronic device is one of a pair of wireless earbuds.

15. The mobile electronic device of claim 10, wherein the symmetry is a radial symmetry about the axis, the axis being a central axis.

16. The mobile electronic device of claim 10, wherein the battery further comprises a weld point at the fourth location, the weld point:
connecting the base exterior surface to the external negative tab; and
comprising a conductive material.

17. The mobile electronic device of claim 16, wherein the battery further comprises an insulative layer between the external negative tab and both the base and the sidewall exterior surfaces, the insulative layer:
starting after the weld point; and
substantially filling an area between the enclosure and the external negative tab.

18. The mobile electronic device of claim 10, wherein the battery further comprises an insulative layer between the top can and the bottom can.

19. The mobile electronic device of claim 18, wherein the top can comprises a raised portion, the raised portion:
situated along the top exterior surface; and
centered at the third location.

20. The mobile electronic device of claim 19, wherein the top can further comprises the external positive tab.
